(19) United States
(12) Patent Application Publication
(10) Pub. No.: US 2006/0207581 A1
(43) Pub. Date: Sep. 21, 2006

(54) Internal combustion engine and an engine head

(76) Inventor: Roberto Tadeu Minetto, (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/564,250

(22) PCT Filed: Aug. 4, 2004
(86) PCT No.: PCT/BR04/00140

§ 371 Date: Jan. 11, 2006

(30) Foreign Application Priority Data
Aug. 6, 2003 (BR) PI0302741-4

(51) Int. Cl. F02M 25/06

(52) U.S. Cl. 123/572

(57) ABSTRACT

The present invention relates to an in-ternal combustion engine comprising at least one engine block (2) and at least one engine head (3) associated to the block. The flock (2) comprises at least one first end (4) provided with a first cavity (5) for receiving a crank-shaft, at least one second end portion (6) associated to the head (3), and at least one first through channel (7) provided with a first end (7′) located in the first cavity (5) and a second end (7″) located in the second end portion (6). The head (3) comprises at least one first end portion (11), a second end portion (12) opposite the first one, and at least one second cavity (9) for positioning mechanical components. The head (3) and the block (2) are associated by cooperation between the first end portion (11) of the head (3) and the second end portion (6) of the block (2), the head (3) having additionally at least one second through channel (10) provided with a first end (10′) located at its end portion (11) and a second end (10″), the first end (10′) of the second through channel (10) cooperating with the second end (7″) of the first through channel (7) of the block (2) and the second end (10″) of the second through channel (10) being non-communicant with the second cavity (9).

The present invention relates to an internal combustion engine, particularly a 4-stroke engine, provided with reciprocating-motion pistons comprising an innovatory positive crankcase ventilation system, which decreases the consumption of engine lubricating oil and reduces the toxicity of the gases expelled by the engine, as well as to an engine head for a 4-stroke engine.

### DESCRIPTION OF THE PRIOR ART

The 4-stroke (admission, compression, explosion and escape) combustion engines provided with reciprocating-motion pistons need a internal-pressure relief system, in order to optimize its functioning.

As it is known, 4-stroke engines that operate according to the Otto or Diesel cycles have an oil sump located at one lower end, which is the container that holds the engine lubricating oil. This oil is moved as far as the engine parts by means of an oil pump or, on more ancient and simple engines, by a catcher positioned on the crankshaft. The lubricating oil, after lubricating the various components of the engine, flows back to the crankcase by gravity.

A not very common variation on some engines, wherein the oil sump does not configure the oil-accumulating reservoir. In this case, there is only one lower engine cover, and an outer reservoir is provided, connected by hoses, in which the oil is held, and the movement of this oil as far as the engine and back to the reservoir is brought about by an oil pump. Engines that are configured in this way are known as dry-sump engines.

However, regardless of the solution employed, there is an internal pressure in the lower region of the engine, close to the oil sump (denominated crankcase region), caused by the reciprocating motion of the engine pistons and by the fact that a portion of the air-fuel mixture admitted into the cylinder leaks to the lower region of the engine through the seal rings. The greater the wear of the engine (corresponding to the increase in the clearances between pistons/rings/cylinders) the more intense this situation will be.

The most important drawback of the existence of this positive pressure in the region of the crankcase is the trend to cause leakages though gaskets and seals located in that region of the engine, as for instance, oil-sump gaskets, crankshaft seals, etc. Besides, it may entail dilution of the lubricating oil by the fuel. Therefore, the considerable increase in the internal positive pressure of the engine causes leakages of lubricating oil. The consequences of these leakages are lowering of the level of engine oil and environmental pollution.

In an extreme case, the increase in internal pressure in the region of the engine crankcase leads to a decrease in the power generated by the engine, due to the pressure that the pistons would encounter while carrying out linear movements in the direction of the crankcase.

In order to prevent this increase in pressure, 4-stroke engines have a positive ventilation system and pressure relief valve that equals the internal pressure of the engine or makes it slightly negative.

In engines produced until about 1970, the positive ventilation system basically consisted of a tube that linked the crankcase to the outside, thus enabling the gas that caused excess pressure to escape. This gas basically contained burned or non-burned air-fuel mixture and dragged droplets of lubricating oil, being highly polluting.

As the environmental legislations of the countries advanced with regard to vehicle pollution, it becomes necessary to direct the gases into the combustion chambers of the engine, to be burned.

Since the problem of pollution caused by gases from the crankcase thrown directly to the atmosphere had been solved, which no longer happened, there was still the drawback the cases from the crankcase dragged particles of lubricating oil that ended up being burned in the combustion chamber, thus reducing the level of lubricating oil and increasing the amount of pollutants emitted through the exhaust of the vehicle.

With a view to reducing the amount of oil dragged by the gases coming from the crankcase, a solution was proposed in U.S. Pat. No. 4,501,234, which discloses a system of passing gas from the crankcase of an internal combustion engine, wherein the engine block has ducts that begin at the lower region of the engine block, where the oil-sump is located, and has communication with a chamber located at the upper portion of the engine head, at least one of the ducts having connection with an oil-separation chamber.

In determined situations of the engine functioning, particularly in low-rotation operation, the high vacuum created by engine aspiration in these conditions sucks gases from the crankcase, and the oil-separation chamber enables one to remove the droplets of lubricating oil from the rest of the gases, which are then burned by the engine. On the other hand, under high rotations, the gases from the crankcase pass through the ducts located in the block and, instead of getting into the oil-separation chamber, go on until they reach the upper part of the head and are led to the intake manifold of the engine. According to that patent, the consumption of oil is reduced, since the two ducts through which the gases pass are not the same used by the lubricating oil that returns to the crankcase after lubricating the mechanical components of the head.

However, the gases, upon reaching the upper part of the head, meet the lubricating oil that is lubricating the mechanical components located therein (valves and/or valve-rods and/or camshafts, among others). At this moment, these gases drag particles of lubricating oil located therein, which are uselessly burned.

Since this patent U.S. Pat. No. 4,501,234 was filed on Nov. 8, 1983, one can conclude that, for the technological stage of that time, the amount of lubricating oil dragged by the gases from the crankcase to the combustion chambers of the engine was satisfactory. However, as the environmental control laws become stricter and stricter, it has become necessary to build a more efficient system.

Another solution that reduces the consumption of lubricating oil was disclosed in U.S. Pat. No. 5,542,402. According to this document, a system of positive ventilation of the crankcase was developed, which is provided with a centrifugal oil separator, operatively associated with the crankshaft of the engine by means of a pulley. When the centrifugal separator turns, it brings about separation of the oil by centrifugation of the rest of the gases, which then are led to the intake manifold of the engine and burned together with the rest of the air-fuel mixture. The lubricating oil separated is in turn led back to the crankcase.

In spite of reducing the amount of lubricating oil burned inside the engine, this device has a number of disadvantages, namely:
more complexity of manufacture and costs, because this is a moveable mechanical component;
tendency to defects due to the time of use, such as wear of bearings, etc.;
need for a driving element (belt, chain, gears, etc.)
need for a considerable room for installation, which becomes critical in the designs of new vehicles, wherein the room intended for the mechanical components tend to be more and more reduced and is occupied by other auxiliary systems associated to the crankshaft, such as air-conditioning compressors and compressed-air generators, hydraulic steering system pumps, volumetric compressors driven by belts (blowers), etc.;
absorption of the engine power for its functioning, suffering a drop in performance and an increase in the consumption of fuel of the vehicle provided with an engine equipped with this device, which is particularly undesirable on vehicles with underdimensioned engines for the weight which they have to bear.

Further, other less relevant solutions have been proposed, but all of them had failures in functioning , due to the fact that the size of the particles of oil dragged with the gases from the crankcase varies much, as a function of the numberless variables, such as situation of engine operation, amount and type of oil used, ambient temperature, etc. These solutions used to employ undulated separation plates, fiber filters and electrostatic discharges, among others.

Finally, it should be noted that, in the case of more modern engines provided with more advanced technology, the presence of particles of lubricating oil in the cases coming from the crankcase entails other draw-backs, namely:
presence of oil in the volumetric compressor or compression tube (if any) and other components of the air-inlet circuit of these engines, as for example, heat exchanger of the inlet air (also known as intercoolers), leading to a decrease in efficiency and, in extreme cases, even to mechanical defects on these components;
rise in the level of emission of pollutants of the engines, mainly carbon monoxide (CO), nitrogen oxides (NOx) and particulate material, which result from incomplete combustion of the lubricating oil;
reduction of the useful life of the catalytic converters of the exhaust system of the vehicle, which lose their capability of catalyzing chemical reactions between the various combustion gases expelled by the engine with a view to obtain less harmful products;
due to the preceding item, a vehicle with a short time of use may present gas emissions higher than those permitted by law, and the change of the catalytic converter becomes imperious in order to avoid fines and restrictions to the use of the vehicle during inspections, a procedure that occurs in many countries; this is a great drawback due to the widely-known high cost of a catalytic converter for replacement.

So far, no 4-stroke internal combustion engine had been developed and provided with a system of positive ventilation of the crankcase that considerably reduces the amount of lubricating oil dragged by the gases coming from the crankcase, without having disadvantages such as high cost and other limitations that reduce its application to engines.

### OBJECTIVES OF THE INVENTION

An objective of the present invention is to provide an internal combustion engine, particularly a 4-stroke engine having at least one piston with reciprocating motion, provided with a system of positive ventilation of the crankcase that brings about a reduced drag of particles of oil by the gases coming from the crankcase, due to the fact that it comprises channels for circulation of the gases, in which no lubricating oil is encountered. In this way, the gases, upon intake by the engine together with the air-fuel mixture, exhibit a very reduced amount of dragged lubricating oil.

Another objective of the present invention is to provide an engine head, particularly for use on a 4-stroke internal combustion engine, comprising channels for circulation of the gases coming from the crankcase, in which no engine-lubricating oil is encountered.

### BRIEF DESCRIPTION OF THE INVENTION

The objectives of the present invention are achieved by means of an internal combustion engine comprising at least one engine block and at least one head associated to the block;
the block comprising at least one first end portion provided with a first cavity for receiving a crankshaft, at least one second end portion associated to the head, and at least one first through channel provided with a first end located in the first cavity and a second end located at the second end portion;
the head comprising at least one first end portion, a second end portion opposite the first one, and at least one second cavity for receiving mechanical components;
the head and the block being associated by cooperation between the first end portion of the head and the second end portion of the block;
the head additionally having at least one second through channel provided with a first end located at its end portion and a second end, the fist end of the second through channel cooperating with the second end of the first through channel of the block and the second end of the second through channel being non-communicant with the second cavity.

Further, the objectives of the present invention are achieved by means of an engine head, particularly for association with a block of an internal combustion engine, comprising at least one first end portion, a second end portion opposite the first one, and at least one second cavity for positioning mechanical components, the head additionally having at least one second through channel provided with a first end located at its first end portion and a second end non-communicant with the second cavity.

The present invention has the following advantages:
avoiding the need for complicated, expensive and unreliable oil-separation systems, like that disclosed in U.S. Pat. No. 5,542,402;
reducing, in a considerably way, the consumption of lubricating oil;
reducing the amount of oil impregnated in the inlet manifold, compressors and intercoolers (if any);
decreasing the emission of pollutants, mainly carbon monoxide (CO), nitrogen oxides (NOx) and particulate material, which result from incomplete combustion of the lubricating oil;
increase in the useful life of the catalytic converters existing in the exhaust system of the vehicles.

### BRIEF DESCRIPTION OF THE DRAWINGS

The present invention will now be described in greater detail with reference to an embodiment represented in the drawings.

FIG. 1 is a schematic cross-sectional view of the block and of the head of the internal combustion engine of the present invention;

FIG. 2 is a schematic cross-sectional view of the valve cover of the internal combustion engine of the present invention;

FIG. 3 is a cross-sectional view of the head of the internal combustion engine of the present invention; and

FIG. 4 is a cross-sectional view of the block of the internal combustion engine of the present invention.

### DETAILED DESCRIPTION OF THE FIGURES

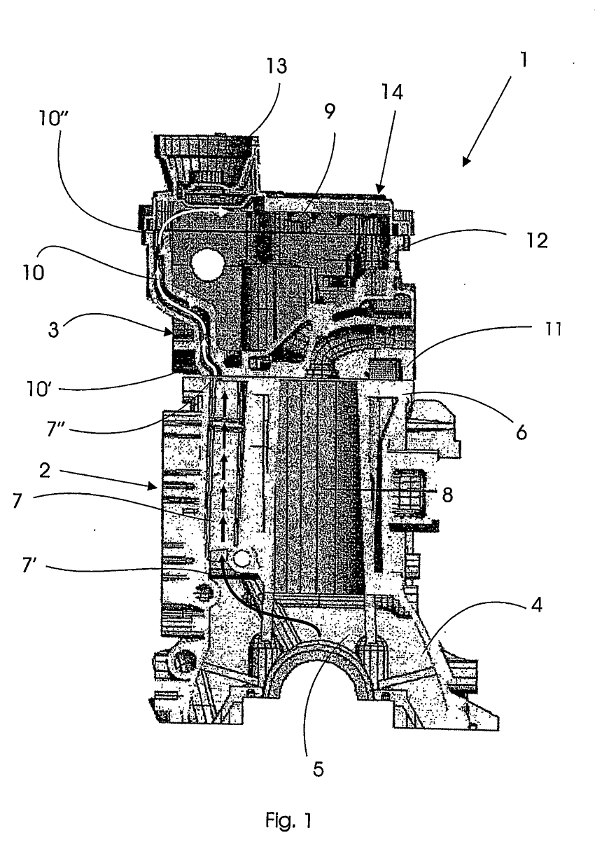

According to a preferred embodiment and as can be seen in FIG. 1, the present invention relates to an internal combustion engine, particularly a 4-stroke engine.

A 4-stroke internal combustion engine like the engine 1 designed now has an engine block 2, which contains at least one cylinder 8 and at least one head 3 associated to the block 2.

As a rule, an engine comprises only a block 2, but there are engines composed of two or more associated blocks 2, although they are an absolute minority.

With regard to the number of cylinders, there are internal combustion engines 1 with one to more than sixteen cylinders, the engines 1 having 1 to 8 cylinders being the commonest ones.

In general, the architecture of an internal combustion engine, at least for those of vehicle specification, may have the cylinders 8 arranged in line of in a V-arrangement, although there are other less used variations.

The engine block 2 comprise at least one first end portion 4, which is provided with a first cavity 5 (named crankcase) for receiving the crankshaft, and at least one end portion 6, which is associated to the engine head 3.

With regard to the head 3, usually an engine with the cylinders 9 arranged in line has a single head 3 associated to the block 2, whereas engines with the cylinders 8 arranges in “V” have a head 3 for each cylinder bedplate, but it is evident that this rule may vary, since there are internal combustion engines on which each cylinder has its respective head 2, independently of the number of cylinders and their arrangement. In the same way, it is technically possible and feasible to build engines provided with one head 2 for every two cylinders, or else any other necessary or desirable variation.

The head 3 comprises at least one first end portion 11, associated to a second end portion 6 of the block 2, a second end portion 12 opposite the first one, and at least one second cavity 9, usually located in the region of the second end portion. The second cavity is provided to allow the positioning and functioning of various mechanical components, as for example, valves and/or valve-rods and valve springs and/or camshaft(s) and/or rockers, among others (none of them illustrated).

Initially, it should be noted that the internal combustion engine 1 designed now may have any desired constructive configuration, as long as it is functional.

Additionally, 4-stroke internal combustion engines 1 have one oilsump (not shown) located at the first end portion 4 of the block 2, and that configures a container for holding the engine lubricating oil. The lubricating oil should be pumped in such a way that it reaches all the movable parts of the engine 1, thus enabling it to function without excessive wear between the movable parts due to the increased friction and consequent heat generated, that is to say, it maintains the friction between the components at a reduced value.

For this purpose, the oil is moved as far as the various parts of the engine by means of an oil pump or, in the case of older and simpler engines, by means of a catcher positioned at the crankshaft and, after lubricating the various engine components, it flows back to the crankcase by gravity through oil-return galleries (not shown).

A not very common variation is present on some engines, where the oil-sump configures the oil accumulating reservoir. In this case, there is only a lower engine cover, and an outer reservoir is provided, which is connected to the engine by means of hoses, in which the oil is held, and the movement of this oil as far as the engine and back to the reservoir is brought about by an oil pump. The thus configured engines are known as dry-sump engines, and represent a minority of the existing internal combustion engines.

In order to convert the chemical energy contained in the fuel into mechanical energy, the internal combustion engine 1 comprises a piston (not shown) inside each cylinder 8, which is articulated to a rod (not shown) that, in turn, is articulated to a crankshaft (not shown either).

As the name itself indicates, the functioning of a 4-stroke engine is based on four strokes of functioning, namely:
intake, when the air-fuel mixture gets into the combustion chamber (defined by the upper portion of the cylinder 8, head 3 and piston top) due to the vacuum created by the movements of the piston, by means of intake valves, which open;
compression, when the air-fuel mixture is compressed by the piston;
explosion, when the spark generated by one or more spark plugs ignite the air-fuel mixture, generating a violent explosion, which moves the piston rapidly;
exhaust, when the movements of the piston expels the gas by-products of the explosion through the escape valve(s),which open.

It is important to note that the explosion stroke is the only one that generates energy for the engine to function. Apart from that, the piston-rod-crankshaft assembly moves by inertia. The intake valves and escape valves (not shown) are actuated by means of at least one camshaft (not shown), which moves synchronically with respect to the crankshaft.

It should be further clarified that the above explanation refers to a 4-stroke engine, which operates according to the Otto cycle, since in the engines that operate under the Diesel cycle there are some minor differences, which characterizes this type of functioning cycle, namely:
during the intake phase, only atmospheric air is admitted;
in the compression phase, air is compressed at extremely high compression ratios (usually more than 15 to 1) and reaches a high temperature inside the combustion chamber, when the diesel oil is injected, which, upon coming into contact with this heated air, ignites spontaneously and instantly (configuring the explosion stroke) and moves the piston.

Whatever the type of internal combustion engine, the piston comprises at least two rings, the function of which is to effect the sealing between its side wall an the cylinder 8 wall and to scrape off the lubricating oil that may be located therein.

During the phase of compressing the air-fuel mixture (in the case of Otto engines) or atmospheric air (in the case of Diesel engines), some of these gases, however little it may be, passes through the barrier represented by the rings and reaches the first cavity 5. With the constant work of the engine, the accumulation of gases in the first cavity 5 tends to cause an increase in positive pressure in this region (caused by the reciprocating movement of the pistons), which may bring a number of drawbacks, which have already been mentioned before, such as leakages through the gaskets and seals located in that region of the engine (for example, oil-sump gaskets and crankshaft seals), besides entailing dilution of the lubricating oil by the fuel.

This situation is considerably aggravated when the engine has suffers wears that manifest in the form of larger clearances between pistons/rings/cylinders.

In order to prevent these drawbacks, the 4-stroke internal combustion engines have a positive-ventilation system that makes the pressure slightly negative in the first cavity 6 or equals it to the atmospheric pressure, which has already been detailed in the description of the prior art presented in this specification.

The innovation in the internal combustion engine 1 of the present invention is exactly in the positive ventilation system of the first cavity 5, better known as crankcase positive pressure system, which does not has the disadvantages of the existing systems and bring a number of vantages, which will be described below.

For this purpose, the engine block 2 has at least one first through channel 7, provided with a first end 7′ located in the first cavity 5 and a second end 7″ located in the second end 6.

The first through channel 7 does not have any element restricting the passage of gases from its first end 7′ to its second end 7″.

Evidently, the block, 2 may have more than one first channel 7, the number thereof being a mere option of the manufacturer. Also, the dimensions of this first channel 7 may be any ones, as long as they are functional.

The head 3, in turn, additionally comprises at least one second through channel 10 provided with a first end 10′ located in its end portion 11 and a second end 10″, preferably located in the second end portion 12.

Alternatively, the second end 10″ of the second through-channel may be located at other points of the head 3, as for instance at its side walls or elsewhere.

However, whatever the positioning of the second end 10″, it does not communicate with the second cavity 9, that it, it does not end in the region where the second cavity 9 is located, for reasons that will be mentioned later.

When the engine 1 of the present invention is assembled, the head 3 and the block 2 are associated by cooperation between the first end portion 11 of the head 3 and the second end portion 6 of the block 2. In addition, it is imperious that the first end 10′ of the second through channel 10 of the head 3 and the second end 7″ of the first through channel 7 of the block 2 should be aligned and cooperating/communicating with each other.

Therefore, the head 3 will have as many second through-channels 10 as the first through-channels 7 of the block 2, sized in a functional way.

Preferably, the internal combustion engine 1 has a head gasket (not shown) that functions as a contact interface between the first end portion 11 of the head 3 and the second end portion 6 of the block 2. Evidently, the head gasket has openings that enable cooperation/communication between said first and second channels 7, 10.

Finally, the engine 1 comprises a valve 13 for controlling the internal pressure of the crankcase, associated to the second end 10″ of the second through-channel 10 of the head 3.

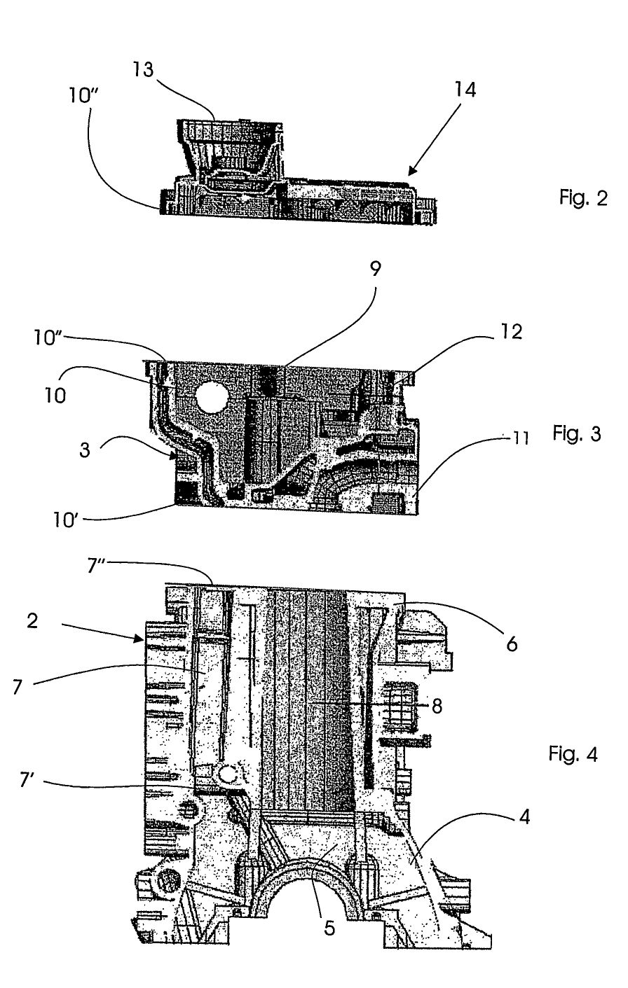

In a first preferred embodiment of the present invention, the second end 10″ of the second through channel 10 of the head 3 is directly linked to the valve 13, whereas a second preferred embodiment, which is that illustrated in FIGS. 1 to 4, the head 3 of the engine 1 comprises at least one valve cover 14 containing an inner tubing (not shown) provided with a first end associated to the second end 10″ of the second through channel 10 and a second end associated to the valve 13.

The valve 13 for controlling the internal pressure of crankcase is also linked to the intake manifold of the engine (a place through which the air-fuel mixture or the atmospheric air is admitted by the engine).

### Functioning of the Invention

Whatever the configuration of the engine 1 of the present invention is, its working generates an increase in internal pressure in the first cavity 5,due to the leakage of the air-fuel mixture or compresses atmospheric air (depending upon the type of cycle by which the engine operates whether Otto or Diesel) and to the reciprocating movements of the engine piston (s).

With the increase in internal pressure in that region, the gases present there run through the first through channel 7 (as illustrated by the black arrows in FIG. 1) and then through the second through channel 10 (as indicated by the white arrows in FIG. 1) until they reach the second end 10″ of this second channel. Then, the gases meet the crankcase-internal-pressure control valve 13, which is directly associated to the second end 10″ of the second channel 10, or else they meet it after they have passed through the internal tubing of the valve cover 14.

From there onwards, two situations may occur, namely:
if the pressure exerted by the gases on the valve 13 still is not very high (according to the design parameters, which may vary depending upon the configuration of the engine 1), the valve 13 does not open and the gases continue to occupy the space available in the first cavity 5, the first and second through channels 7, 10 and the tubing of the valve cover 14, if any;
if the pressure exerted by the gases is higher than a permissible determined value, the valve 13 will open and the gases go to the intake manifold; and these gases may be led as far as or beyond the throttle plates that usually exist and are associated to the accelerator pedal of the vehicle (to control the acceleration/rotation of the engine 1).

The great innovation of the engine 1 of the present invention is the fact that both the first through channel 7 and the second through channel 10 do not have communication with the movable mechanical elements of the engine, which are lubricated, and so the gases do not meet at any time the lubricating oil while the latter is lubricating the engine or escapes to the crankcase, which greatly reduces the amount of oil droplets that is dragged by them. In this way, very little oil is burned in the combustion chambers, which brings a number of functioning advantages.

On the contrary, the known positive-ventilation systems would at some time cause the gases from the crankcase to pass by a place of the engine where lubricating oil would be present (generally in the second cavity 9 of the head), thus causing a large number of droplets of oil to be dragged and end up being burned in the engine 1.

As main advantages, the present internal combustion engine 1 has the following:
avoiding the need for complicated, expensive and unreliable oil-separation systems, like that disclosed in U.S. Pat. No. 5,542,402;
reducing, in a considerably way, the consumption of lubricating oil;
reducing the amount of oil impregnated in the inlet manifold, compressors and intercoolers (if any);
decreasing the emission of pollutants, mainly carbon monoxide (CO), nitrogen oxides (NOx) and particulate material, which result from incomplete combustion of the lubricating oil;
increase in the useful life of the catalytic converters existing in the exhaust system of the vehicles.

It should be noted that the engine head 3, according to the teachings hereof is also an invention, due to the fact that it additionally has at least one second through channel 10, provided with a first 10′ located in its first end portion 11 and a second end 10″, which does not have communication with the second cavity 9.

A preferred embodiment having been described, it should be understood that the scope of the present invention embraces other possible variations, being limited only by the contents of the accompany claims, which include the possible equivalents.

1. An internal combustion engine comprising at least one engine block (2) and at least one engine head (3) associated to the block (2),
the block (2) comprising at least one first end (4) provided with a first cavity (5) for receiving a crankshaft, at least one second end portion (6) associated to the head (3), and at least one first through channel (7) provided with a first end (7′) located in the first cavity (5) and a second end (7″) located in the second end portion (6),
the head (3) comprising at least a first end portion (11), a second end portion (12) opposite the first one, and at least one second cavity (9) for positioning mechanical components,
the head (3) and the block (2) being associated by cooperation with the first end portion (11) of the head (3) and the second end portion (6) of the block (2),
the engine (1) being characterized in that the head (3) additionally has at least one second through channel (10) provided with a first end (10′) located at its first end portion (11) and a second end (10″), the fist end (10′) of the second through channel (10) cooperating with the second end (7″) of the first through channel (7) of the block (2), and the second end (10″) of the second through channel (10) being non-communicant with the second cavity (9).

2. An engine according to claim 1, characterized in that the second end (10″) of the second through channel (10) is associated to a valve (13) for controlling the crankcase internal pressure.

3. An engine according to claim 1, characterized in that it comprises at least one valve cover (14) provided with an internal tubing to which is associated the second end (10″) of the second through channel (10).

4. An engine according to claim 3, characterized in that the crankcase-internal-pressure control valve (13) is associated to the internal tubing of the valve cover (14).

5. An engine head, particularly for association to a block (2) of an internal combustion engine (1), comprising at least one first end portion (11), one second end portion (12) opposite the first one, and at least one second cavity (9) for positioning mechanical components, the head (3) being characterized in that it additionally has at least one second through channel (10) provided with a first end (10′) located in its first end portion (11) and a second end (10″) non-communicant with the second cavity (9).

6. A head according to claim 5, characterized in that the second end (10″) of the second through channel (10) is associated to a crankcase-internal-pressure control valve (13).

7. A head according to claim 5, characterized in that it additionally contains at least one valve cover (14) provided with an internal tubing, the second end (10″) of the second through channel (10) being associable to the internal tubing of the valve cover (14).

8. A head according to claim 7, characterized in that the crank-case-internal-pressure control valve (13) is associated to the internal tubing of the valve cover (14).
